(19) United States
(12) Patent Application Publication
(10) Pub. No.: US 2016/0379029 A1
(43) Pub. Date: Dec. 29, 2016

(54) HIGH CAPACITY 2D COLOR BARCODE DESIGN AND PROCESSING METHOD FOR CAMERA BASED APPLICATIONS

(71) Applicant: KONICA MINOLTA LABORATORY U.S.A., INC., San Mateo, CA (US)

(72) Inventor: Gang Fang, San Bruno, CA (US)

(73) Assignee: KONICA MINOLTA LABORATORY U.S.A., INC., San Mateo, CA (US)

(21) Appl. No.: 14/747,334

(22) Filed: Jun. 23, 2015

(51) Int. Cl. G06K 7/14

(52) U.S. Cl. CPC G06K 7/146; G06K 7/1426; G06K 7/1417

(57) ABSTRACT

A processing method for a color barcode image captured by a camera or barcode reader. The barcode includes color data cells and multiple large black locators which are located at the four corners of the barcode, along the four borders, and inside the barcode forming an array. The locators are first identified. Perspective correction is performed by dividing the barcode image into smaller regions each containing four locators, individually transforming each region into its original shape e.g. square, and spatially combining them into the barcode image. Illumination correction is applied to the barcode image based on average pixel intensities of the locators, by calculating an illumination correction map using the average densities of the locators and 2-dimensional interpolation for pixel positions other than the locators.

### BACKGROUND OF THE INVENTION

Field of the Invention

This invention relates to the design and decoding of two-dimensional (2D) color barcode, and in particular, it relates to the design and decoding of 2D color barcode for camera based applications.

Description of Related Art

Barcode is an optical machine-readable representation of data. A 2D color barcode is formed of small square or rectangular cells arranged in a two-dimensional manner, e.g., in both horizontal and vertical directions, and one color is used for each cell. Different colors represent different data values. The relation between the data capacity of the barcode and the cell number and the number of colors can be expressed as

Data capacity=(Cell Number)×log₂(Num of color representations)

A barcode design that uses small cell sizes and more color representations can achieve a relatively high data capacity in a given area. However, various factors limit how small cells can be.

When a 2D color barcode is printed on paper or displayed on a display screen such as the screen of a mobile device, and read by a camera-based barcode reader (as opposed to a flat-bed type scanner), perspective projection and non-uniform illumination may present a challenge for decoding the barcode.

### SUMMARY

Accordingly, the present invention is directed to a method and related apparatus of processing a 2D color barcode that substantially obviates one or more of the problems due to limitations and disadvantages of the related art.

An object of the present invention is to provide corrections for perspective projection and non-uniform illumination for barcode image acquired by a camera based barcode reader.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for processing a two-dimensional color barcode in a captured barcode image, the barcode image consisting of a plurality of pixels, the barcode having a known layout including a plurality of color data cells and a plurality of locators each formed of a plurality of black pixels, the locators being located at different positions throughout the barcode, the method including: (a) identifying the plurality of locators in the color barcode image and determining their positions; (b) calculating an average pixel intensity for each locator; (c) computing a 2D illumination correction map based on the positions and the average pixel intensities of the locators, the illumination correction map consisting of an illumination correction function for each pixel position of the barcode image, wherein the illumination correction function for the position of each locator is a function that maps the average pixel intensity of that locator to a pixel value of ideal black, and wherein the illumination correction function for each pixel position in a data cell is derived using 2-dimensional interpolation from the illumination correction functions at the positions of at least some of the locators; and (d) applying the illumination correction map to the color barcode image, by applying the illumination correction function for each pixel position to pixel value of the barcode image at that pixel position, to computer a corrected barcode image.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a color barcode layout according to an embodiment of the present invention.

FIG. 2 schematically illustrates a method for processing a barcode image according to an embodiment of the present invention.

FIG. 3 schematically illustrates a data processing apparatus in which embodiments of the present invention may be implemented.

### DETAILED DESCRIPTION OF PREFERRED EMBODIMENTS

An aspect of the present invention is the layout design of a 2D color barcode which will be printed on media or shown on a screen of a mobile device. Another aspect of the present invention is a decoding process and algorithm suitable for decoding 2D color barcode from images captured via a camera. The design of the 2D color barcode contains features that facilitate the processing and decoding from camera-captured barcode images.

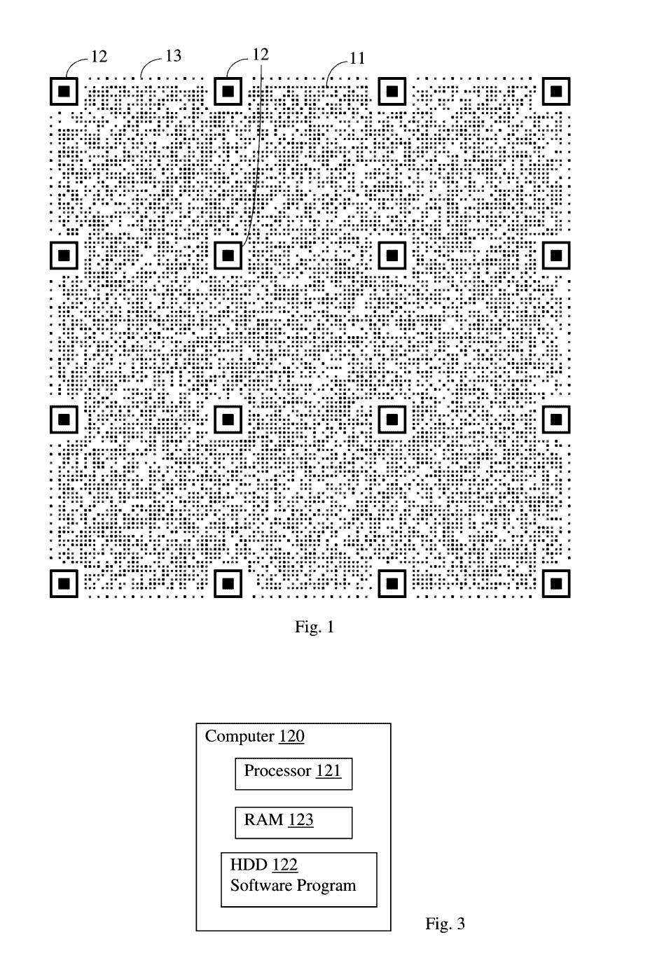

FIG. 1 depicts the layout of an exemplary color barcode according to an embodiment of the present invention. The color barcode includes a plurality of data cells 11 forming a two-dimensional array, each cell having one of a plurality of colors. In a preferred embodiment, the plurality of colors are cyan (C), magenta (M), white (W) (i.e., unprinted), and black (K), and each cell can represent 2 bits of information. CMYK are the primary colors used in typical printers, and each of them is printed by one colored ink and referred to as a color channel. In the color barcode layout of FIG. 1, the primary color yellow (Y) is replaced with white (W), i.e., unprinted cells. Therefore, each cell in the barcode is printed with one ink or unprinted, and the color of each cell will be uniform. Each cell has a defined size, and cells are separated by defined distances. Preferably the cells are square shaped, form columns and rows that are aligned in the vertical and horizontal directions on a grid, and the row distance and column distance are equal. In one particular embodiment, the cell size is 3×3 pixels and the distance (the width of the white space) between cells is 2 pixels in both horizontal and vertical directions. In this example, the grid is a square grid. Alternatively, the grid may be a rectangular grid.

The barcode has a plurality of locators 12 located at the four corners of the barcode, along the borders of the barcode, as well as in the interior of the barcode. In the illustrated example, sixteen locators 12 are provided, forming a 4×4 array; four locators are located at the corners, eight are located along the borders, and four are located in the interior of the barcode. As will be seen later, the locators 12 can provide position reference within the whole barcode to aid image processing and decoding. The locators are preferably black and substantially larger than the data cells, which make them relatively easy to identify in the image. In the illustrate embodiment, each locator is formed by a solid black square surrounded by a white space and then a black border; the square is 13×13 pixels (i.e. as wide as three columns and three rows of data cells), the white space is 7 pixels wide (i.e. equivalent to the white space created when a column or row of data cells are removed in the data cell area), and the black border is 3 pixels wide (i.e. the same width as the data cells). Thus, each collator 12 is 33×33 pixels in size and occupies the space equivalent to 7×7 data cells in the data cell array.

The barcode also has a plurality of border reference cells 13 located along the four borders of the barcode between the locators. The border reference cells 13 include cyan, magenta and black reference cells that are arranged in a predefined color sequence, e.g. a repeating sequence of C, M, B in the illustrated example. In other words, the color of each border reference cell is known. The reference cells can provide channel offset (global and local) information and color information that is useful in the decoding process. In one embodiment, the border reference cells 13 have the same size as the data cells 11, so that the color densities of these reference cells are similar to those of the data cells.

The border reference cells 13 are separated from each other, from the locators 12 and from the data cells 11 by larger distances than the cell separation in the inside data cell array in order to avoid the potential overlap of reference cells. In the illustrated example, the distance (the white space) between two adjacent reference cells, and between reference cells and adjacent data cells, is 7 pixels (i.e. equivalent to the white space created when a column or row of data cells are removed in the data cell area). The locator 12 and the adjacent reference cells 13 are separated by this distance or a larger distance.

An asymmetry may be designed into the barcode so that one of the four locators in the corners can be distinguished from the others, which is useful in the decoding process. This may be achieved in any suitable ways. For example, one corner locator may have a different shape than the others. An asymmetry may also be designed into the barcode by using different or asymmetric color sequences of the reference cells along the borders. Other additional features may be designed into the barcode as well, such as verification cells that encode the data length and ECC of the barcode, etc.

In one particular example, the grid for a barcode has 124 columns and 124 rows. Excluding the white spaces, the locators and the reference cells, about 13500 data cells can be used to store information in each barcode. Multiple barcodes can be placed adjacent to each other on the same page with a white space of, for example, 20 pixels between them. For a print resolution of 600 dpi, a barcode will take about 1.05×1.05 square inches of space. Thus, up to 7×10 bar codes may be placed on a letter sized page.

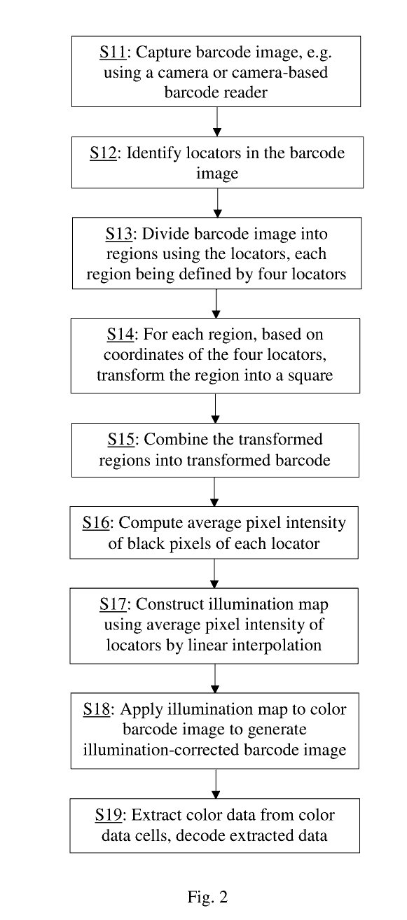

A barcode image processing method for processing a barcode having the above design is described below with reference to FIG. 2. First, a barcode image is captured (step S11). The barcode having the above-described layout design has been printed on paper or displayed on a display screen such as the screen of a mobile device. In this step, the barcode image, which is a color image, is typically captured using a camera or a camera-based barcode reader with the printed sheet or the screen held in front of the barcode reader or camera. Of course, the barcode image may also be captured using a scanner.

Next, the locators in the barcode image are identified (step S12). Any suitable techniques may be used to identify the locators. In one example, the color barcode image is converted to a grayscale image and then binarized, and the locators are identified from the binary image.

Because the barcode image is captured using a barcode reader or camera, the printed sheet or mobile screen on which the barcode is printed or displayed may have been held at an angle with respect to the barcode reader or camera. As a result the barcode in the image are often not a square but contains perspective distortion. Correction of perspective distortion is performed for the barcode image in steps S13-S15. This process is performed on the original color image of the barcode using the locators identified in step S12.

First, the color image of the barcode is divided into smaller regions using the multiple locators 12, so that each region is defined by four locators at its corners (step S13). For example, the barcode shown in FIG. 1, which has 4×4 locators, will be divided into nine regions. These regions may have different perspective distortion, e.g. if the printed sheet was not flat when the barcode image was captured. For each region, a transformation (projection) is applied to the region to transform it to its original shape as defined by the barcode layout design, such as a square with horizontal and vertical sides (step S14). In this step, the coordinates of the four locators that defined the region are used to compute the transformation, i.e. one that transforms the four locators to the four corners of the original shape (e.g. a square), and the computed transformation is then applied to the entire region. Then, all of the transformed regions are spatially combined together to generate a transformed barcode image (step S15). This barcode image will have the shape of the original layout, such as a square.

Because the barcode image is captured using a barcode reader or camera, the pixel intensities of the image are affected by lighting conditions and other conditions which may cause the pixel intensities to be non-uniform across the barcode. Thus, in steps S16-S18, pixel intensity correction is applied to the barcode image, again using the locators 12. This process is applied to the transformed color barcode image obtained in step S15.

First, the average pixel intensity of the black pixels of each locator 12 is computed (step S16). A 2D illumination correction map, which consists of an illumination correction function for each pixel position of the barcode image, is constructed using the positions and the average pixel intensities of the locators of the barcode (step S17). More specifically, the illumination correction function for the pixel position of each locator (defined by its center) is a function that maps the average pixel intensity of that locator to the pixel value of ideal black; at each pixel position other than the locators, the illumination correction function is derived using 2-dimensional interpolation based on the illumination correction functions at the positions of nearby locators. The interpolation may be a linear interpolation, cubic or spline interpretation, etc.

In a preferred embodiment, where the ideal black value is the maximal pixel value of the color image (e.g. 255 for 8-bit data), the illumination correction function at the pixel position of each locator is a multiplier which, when applied to the average pixel intensity of that locator, gives the ideal pixel value for black. In other words, the multiplier is the ratio of the pixel value for ideal black to the average pixel intensity of that locator. At each pixels position other than the locators, the illumination correction function is a multiplier whose value is computed by 2-dimensional interpolation from the multiplier values at nearby locator positions (e.g. the four nearby locators). Thus, such a 2D illumination correction map is a 2D map having the same size as the barcode image, and the pixel values of the 2D map are the multiplier values calculated in the above described manner.

Note here that in this example the definition of black and white is such that ideal black has the maximal pixel value. The pixel values of ideal black and white are a matter of definition. If a different definition is used where ideal black has a pixel value zero, then the illumination correction function at the pixel position of each locator will be one that maps the average pixel intensity of that locator to zero, and again the illumination correction function for pixel positions other than the locator are derived using 2-dimensional interpolation. This is mathematically equivalent to the example where the definition of black is the maximal pixel intensity.

After the illumination correction map is constructed, it is applied to the color barcode image (step S18). In other words, the illumination correction function for each pixel position is applied to the pixel value of the barcode image at that pixel position. In the above preferred embodiment, the pixel value of each pixel of the barcode imaged is multiplied by the corresponding multiplier of the 2D illumination correction map. This correction is separately applied to each color channel of the pixel value. As a result, an illumination-corrected color barcode image is generated.

The result of perspective distortion correction (steps S13-S15) and illumination correction (steps S16-S18) is a corrected barcode. After these corrections, a decoding process is applied to extract the color data of the data cells and decode the extracted data (step S19). Any suitable decoding method may be used to extract the color data of the data cells; one example is described in commonly owned U.S. patent application Ser. No. 14/290,595, filed May 29, 2014.

In the illustrated embodiment, sixteen locators are located in the corners, along the borders and inside the barcode. In other barcode designs, different numbers and distributions of locators may be used, depending on the size of the barcode. In some examples, four locators located at the corners of the barcode may be sufficient.

The above-described barcode image processing method applies illumination correction to the barcode image. More specifically, it uses multiple locators distributed throughout the barcode to calculate an illumination correction map which is then applied to the entire barcode. This is motivated by the fact that the data cells are color cells and are small, and image quality of camera-captured barcode images is often low.

The color barcode image processing methods described here can be implemented in a data processing system such as a computer 120 as shown in FIG. 3. The computer 120 comprises a processor 121, a storage device (e.g. hard disk drive) 122, and an internal memory (e.g. a RAM) 123. The storage device 122 stores software programs, which are read out to the RAM 123 and executed by the processor 121 to carry out the methods. In one aspect, the invention is a method carried out by a data processing system. In another aspect, the invention is computer program product embodied in computer usable non-transitory medium having a computer readable program code embedded therein for controlling a data processing apparatus to carry out the method. In another aspect, the invention is embodied in a data processing system.

It will be apparent to those skilled in the art that various modification and variations can be made in the color barcode image processing method and related apparatus of the present invention without departing from the spirit or scope of the invention. Thus, it is intended that the present invention cover modifications and variations that come within the scope of the appended claims and their equivalents.

1. A method for processing a two-dimensional color barcode in a captured barcode image, the barcode image consisting of a plurality of pixels, each pixel having a color pixel value including a plurality of color channels, the barcode having a known layout including a plurality of color data cells and a plurality of locators each formed of a plurality of black pixels, the locators being located at different positions throughout the barcode, the method comprising:
(a) identifying the plurality of locators in the color barcode image and determining their positions;
(b) calculating an average pixel intensity for each locator;
(c) computing a 2D illumination correction map based on the positions and the average pixel intensities of the locators, the illumination correction map consisting of an illumination correction function for each pixel position of the barcode image, wherein the illumination correction function for the position of each locator is a function that maps the average pixel intensity of that locator to a pixel value of ideal black, and wherein the illumination correction function for each pixel position in a data cell is derived using 2-dimensional interpolation from the illumination correction functions at the positions of at least some of the locators; and
(d) applying the illumination correction map to the color barcode image, by applying the illumination correction function for each pixel position to each color channel of the pixel value of the barcode image at that pixel position, to computer a corrected barcode image.

2. The method of claim 1, wherein the pixel value of ideal black is a maximal pixel value of the color barcode image, wherein the illumination correction function at the pixel position of each locator is a multiplier which is a ratio of the pixel value for ideal black to the average pixel intensity of that locator, and wherein the illumination correction function for each pixel position other than the locators is a multiplier computed by 2-dimensional interpolation from the multipliers at the positions of at least some of the locators, and wherein the applying step includes multiplying a value of each color channel of the pixel value of the barcode image at each pixel position with the illumination correction function for that pixel position.

3. The method of claim 1, wherein step (a) comprises:
converting the color barcode image into a grayscale barcode image;
binarizing the grayscale barcode image a plurality of times, each time using one of a plurality of different binarization thresholds, to generate a plurality of binary images;
identifying locators in each binary image and determining their positions; and
combining the locators identified in the plurality of binary images to generate a combined list of locators.

4. The method of claim 3, further comprising, before the binarizing step:
determining a maximal and a minimal intensity of the grayscale image; and
calculating the plurality of binarization thresholds based on the maximal and minimal intensities.

5. The method of claim 3, wherein the step of identifying locators in each binary image comprises identifying ratios of neighboring horizontal runlengths of black and white pixels that fall within predetermined ranges.

6. The method of claim 1, further comprising, before step (b):
(e) performing perspective distortion correction for the color barcode image, wherein step (b) to (d) are performed on the barcode image after the perspective distortion correction.

7. The method of claim 1, wherein step (e) comprises:
dividing the barcode image into a plurality of regions, each region being defined by four locators at four corners of the region;
for each region, computing a transformation that transforms positions of the four locators to four corners of a predetermined rectangle or square, and applying the transformation to the region;
spatially combine the transformed regions to generate a transformed barcode image.

8. The method of claim 1, wherein the 2-dimensional interpolation is a 2-dimensional linear, cubic or spline interpolation.

9. A computer program product comprising a computer usable non-transitory medium having a computer readable program code embedded therein for controlling a data processing apparatus, the computer readable program code configured to cause the data processing apparatus to execute a process for processing a two-dimensional color barcode in a captured barcode image, the barcode image consisting of a plurality of pixels, each pixel having a color pixel value including a plurality of color channels, the barcode having a known layout including a plurality of color data cells and a plurality of locators each formed of a plurality of black pixels, the locators being located at different positions throughout the barcode, the process comprising:
(a) identifying the plurality of locators in the color barcode image and determining their positions;
(b) calculating an average pixel intensity for each locator;
(c) computing a 2D illumination correction map based on the positions and the average pixel intensities of the locators, the illumination correction map consisting of an illumination correction function for each pixel position of the barcode image, wherein the illumination correction function for the position of each locator is a function that maps the average pixel intensity of that locator to a pixel value of ideal black, and wherein the illumination correction function for each pixel position in a data cell is derived using 2-dimensional interpolation from the illumination correction functions at the positions of at least some of the locators; and
(d) applying the illumination correction map to the color barcode image, by applying the illumination correction function for each pixel position to each color channel of the pixel value of the barcode image at that pixel position, to computer a corrected barcode image.

10. The computer program product of claim 9, wherein the pixel value of ideal black is a maximal pixel value of the color barcode image, wherein the illumination correction function at the pixel position of each locator is a multiplier which is a ratio of the pixel value for ideal black to the average pixel intensity of that locator, and wherein the illumination correction function for each pixel position other than the locators is a multiplier computed by 2-dimensional interpolation from the multipliers at the positions of at least some of the locators, and wherein the applying step includes multiplying a value of each color channel of the pixel value of the barcode image at each pixel position with the illumination correction function for that pixel position.

11. The computer program product of claim 9, wherein step (a) comprises:
converting the color barcode image into a grayscale barcode image;
binarizing the grayscale barcode image a plurality of times, each time using one of a plurality of different binarization thresholds, to generate a plurality of binary images;
identifying locators in each binary image and determining their positions; and
combining the locators identified in the plurality of binary images to generate a combined list of locators.

12. The computer program product of claim 11, wherein the process further comprises, before the binarizing step:
determining a maximal and a minimal intensity of the grayscale image; and
calculating the plurality of binarization thresholds based on the maximal and minimal intensities.

13. The computer program product of claim 11, wherein the step of identifying locators in each binary image comprises identifying ratios of neighboring horizontal runlengths of black and white pixels that fall within predetermined ranges.

14. The computer program product of claim 9, wherein the process further comprises, before step (b):
(e) performing perspective distortion correction for the color barcode image, wherein step (b) to (d) are performed on the barcode image after the perspective distortion correction.

15. The computer program product of claim 9, wherein step (e) comprises:
dividing the barcode image into a plurality of regions, each region being defined by four locators at four corners of the region;
for each region, computing a transformation that transforms positions of the four locators to four corners of a predetermined rectangle or square, and applying the transformation to the region;
spatially combine the transformed regions to generate a transformed barcode image.

16. The computer program product of claim 9, wherein the 2-dimensional interpolation is a 2-dimensional linear, cubic or spline interpolation.
